(19) United States
(12) Patent Application Publication
(10) Pub. No.: US 2015/0166053 A1
(43) Pub. Date: Jun. 18, 2015

(54) CONTROLLER FOR HYBRID VEHICLE

(71) Applicant: Toyota Jidosha Kabushiki Kaisha, Toyota-shi Aichi-ken (JP)

(72) Inventor: Yusuke Kamijo, Toyota-shi Aichi-ken (JP)

(21) Appl. No.: 14/560,417

(22) Filed: Dec. 4, 2014

(30) Foreign Application Priority Data
Dec. 18, 2013 (JP) 2013-261875

(51) Int. Cl. B60W 20/00; B60W 10/08; B60W 10/06; B60W 30/188; B60W 10/02

(52) U.S. Cl. CPC B60W 20/40; B60W 30/1884; B60W 10/02; B60W 10/06; B60W 10/08; Y10S 903/93

(57) ABSTRACT

A clutch is configured to cut off or couple a power transmission path between an engine and a drive system. An engine starter is configured to start the engine. An electric motor is configured to be connected to an output shaft of the engine by coupling the clutch. An electronic control unit is configured to set an engine rotation speed at the time of coupling the clutch after starting the engine when a reverse torque or an external load is large in starting the engine in a state where the clutch is decoupled to be higher than the engine rotation speed when the reverse torque or the external load is small.

### INCORPORATION BY REFERENCE

The disclosure of Japanese Patent Application No. 2013-261875 filed on Dec. 18, 2013 including the specification, drawings and abstract is incorporated herein by reference in its entirety.

### BACKGROUND OF THE INVENTION

1. Field of the Invention

The present invention relates to a controller for a hybrid vehicle, and more particularly, to improvement for suppressing the occurrence of an engine stall.

2. Description of Related Art

A hybrid vehicle is known which includes a clutch cutting off or couple a power transmission path between an engine and a drive system and an electric motor configured to be connected to the output shaft of the engine by coupling the clutch. In such a hybrid vehicle, a technique of suppressing a shock at the time of starting the engine during traveling with the motor has been proposed. An example of such a technique is a drive controller for a hybrid vehicle described in Japanese Patent Application Publication No. 11-178113 (JP 11-178113 A). According to this technique, when an engine is started during traveling with a motor, it is considered that the engine can be appropriately started with a shock suppressed by simply increasing a torque corresponding to a predetermined inertial torque in the output torque of the electric motor.

### SUMMARY OF THE INVENTION

For example, when the starting of an engine is determined by applying a pressure to an accelerator pedal, or the like in a state where a reverse torque or an external load is relatively large such as a state where a vehicle slides on an uphill road, there is a possibility that a reverse torque will act on the output shaft of the engine at the time of coupling the clutch after starting the engine with an engine starter and thus an engine stall will occur. In the related art, such a problem could not be solved. This problem was newly found in the course of the inventor's intense study to improve in performance of a hybrid vehicle.

The invention provides a controller for a hybrid vehicle that suppresses occurrence of an engine stall.

According to a first aspect of the invention, there is provided a controller for a hybrid vehicle. The hybrid vehicle includes an engine, a drive system, a clutch configured to cut off or couple a power transmission path between the engine and the drive system, an engine starter configured to start the engine, and an electric motor configured to be connected to an output shaft of the engine by coupling the clutch. The controller includes an electronic control unit. The electronic control unit is configured to set an engine rotation speed at the time of coupling the clutch after starting the engine, when a reverse torque or an external load is large in starting the engine in a state where the clutch is decoupled, to be higher than the engine rotation speed when the reverse torque or the external load is small.

According to the aspect, the engine rotation speed at the time of coupling the clutch after starting the engine when a reverse torque or an external load is large in starting the engine in a state where the clutch is decoupled is set to be higher than the engine rotation speed when the reverse torque or the external load is small. Accordingly, for example, even when the engine start is determined in a state where the reverse torque or the external load is relatively large such as a state where the vehicle slides on an uphill road, it is possible to appropriately suppress the occurrence of an engine stall at the time of coupling the clutch after starting the engine. That is, it is possible to provide a controller for a hybrid vehicle that can suppress the occurrence of an engine stall.

In the aspect, the electronic control unit may be configured to increase the engine rotation speed at the time of coupling the clutch after starting the engine when the engine starts in a state where the clutch is decoupled. The electronic control unit may be configured to set a degree of increase in the engine rotation speed to be larger as the reverse torque or the external load becomes larger. According to this configuration, it is possible to appropriately suppress the occurrence of an engine stall at the time of coupling the clutch after starting the engine in a practical manner.

In the aspect, the electronic control unit may be configured to couple the clutch and start the engine with a driving force transmitted from the electric motor, when the reverse torque or the external load is less than a threshold value in starting the engine. The electronic control unit may be configured to start the engine using the engine starter in a state where the clutch is decoupled when the reverse torque or the external load is equal to or greater than the threshold value. According to this configuration, the engine can be started with a driving force transmitted from the electric motor by coupling the clutch when the reverse torque or the external load is relatively small and the occurrence of an engine stall can be appropriately suppressed when the reverse torque or the external load is relatively large.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram conceptually illustrating a configuration of a drive system and a control system of a hybrid vehicle to which the invention is suitably applied;

FIG. 2 is a functional block diagram illustrating a principal part of control functions of an electronic control unit illustrated in FIG. 1;

FIG. 3 is a diagram schematically illustrating a state where the hybrid vehicle illustrated in FIG. 1 slides in a reverse direction;

FIG. 4 is a diagram illustrating an example of a relationship used to calculate a degree of increase in engine rotation speed in engine start control which is performed by the electronic control unit illustrated in FIG. 1; and

FIG. 5 is a flowchart illustrating principal parts of the engine start control which is performed by the electronic control unit illustrated in FIG. 1.

### DETAILED DESCRIPTION OF EMBODIMENTS

Hereinafter, an exemplary embodiment of the invention will be described in detail with reference to the accompanying drawings.

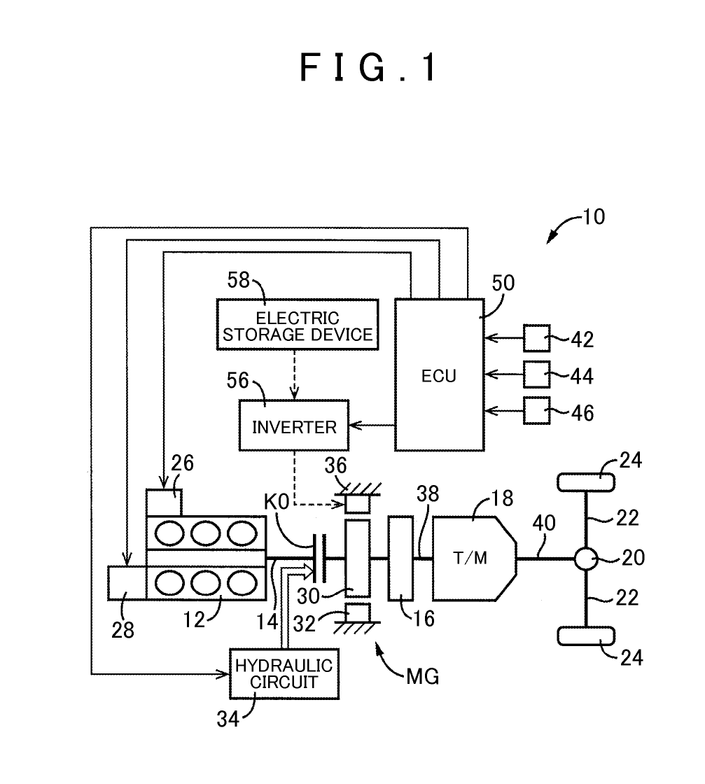

FIG. 1 is a diagram conceptually illustrating a configuration of a drive system and a control system of a hybrid vehicle 10 to which the invention is suitably applied. As illustrated in FIG. 1, the hybrid vehicle 10 according to this embodiment includes an engine 12 and an electric motor MG serving as drive sources. Driving forces generated by the engine 12 and the electric motor MG are transmitted to a pair of right and left vehicle wheels 24 via a torque converter 16, a transmission 18, a differential gear unit 20, and a pair of right and left axles 22. The electric motor MG the torque converter 16, and the transmission 18 are housed in a transmission case 36 (hereinafter, referred to as case 36). The case 36 is a divided of case formed, for example, by aluminum die-casting and is fixed to a non-rotation member such as a vehicle body. According to this configuration, the hybrid vehicle 10 is driven using at least one of the engine 12 or the electric motor MG as a traveling drive source. That is, in the hybrid vehicle 10, plural traveling modes such as an engine-traveling mode, an EV traveling (motor-traveling) mode, and an EHV traveling (hybrid traveling) mode are selectively established. The engine-traveling mode uses the engine 12 as a traveling drive source. The EV traveling (motor-traveling) mode uses the electric motor MG as a traveling drive source. The EHV traveling (hybrid traveling) mode uses the engine 12 and the electric motor MG as traveling drive sources.

The engine 12 is an internal combustion engine such as an in-cylinder injection of gasoline engine or diesel engine in which fuel is directly injected into a combustion chamber. The engine 12 is provided with a starter (starter motor) 26 as an engine starter for starting the engine 12. The starter (starter motor) 26 is configured to crank the engine 12, for example, using electric energy in response to a command supplied from an electronic control unit 50 to be described later. An output controller 28 including a throttle actuator for controlling the operation of an electronic throttle valve, a fuel injector for performing fuel injection control, and an igniter for performing ignition time control is provided to control the driving (output torque) of the engine 12. The output controller 28 performs output control of the engine 12 by controlling the fuel injection from the fuel injector for the fuel injection control and controlling the ignition time of the igniter for the ignition time control, in addition to controlling the operation of the electronic throttle valve through the use of the throttle actuator for the throttle control in response to a command supplied from an electronic control unit 50 to be described later. The output controller 28 may serve as an engine starter for starting the engine 12, for example, by an ignited start.

The torque converter 16 is, for example, a known hydraulic power transmission unit including a pump wheel, a turbine wheel, and a stator wheel. The pump wheel is connected to the crank shaft 14 of the engine 12 via a clutch K0 to be described later. The turbine wheel is connected to an input shaft 38 of the transmission 18. The stator wheel is disposed between the pump wheel and the turbine wheel. The transmission 18 is, for example, an automatic gear-shifting mechanism that includes plural hydraulic frictional engagement units and that selectively sets up plural predetermined gear-shifting stages depending on the combination of engagement or disengagement of the engagement units.

The electric motor MG includes a rotor 30 and a stator 32. The rotor 30 is supported by the case 36 so as to be rotatable about an axis core. The stator 32 is integrally fixed to the case 36 on the outer circumference side of the rotor 30. The electric motor MG is a motor-generator set having functions as a motor generating a driving force and a generator generating a reaction force. The electric motor MG is connected to an electric storage device 58 such as a battery or a capacitor via an inverter 56. The driving of the electric motor MG is controlled by adjusting a driving current supplied to a coil via the inverter 56 through the use of an electronic control unit 50 to be described later. In other words, the output torque of the electric motor MG is controlled to increase or decrease via the inverter 56.

A power transmission path between the engine 12 and the drive system on the downstream side including the electric motor MG and the transmission 18 is provided with a clutch K0 controlling transmission of power in the power transmission path depending on the engagement state. That is, the crank shaft 14 as an output member of the engine 12 is selectively connected to the rotor 30 of the electric motor MG via the clutch K0. The rotor 30 of the electric motor MG is connected to a front cover as an input member of the torque converter 16. The clutch K0 is a multi-disc hydraulic frictional engagement unit of which the engagement state is controlled, for example, by a hydraulic actuator. The engagement state of the clutch K0 is controlled among an engaged (completely-engaged) state, a slip engaged state, and an opened (completely-opened) state depending on a hydraulic pressure supplied from the hydraulic circuit 34. That is, the torque capacity thereof is controlled depending on the hydraulic pressure supplied from the hydraulic circuit 34. By setting the clutch K0 to the engaged state, the transmission of power (coupled) through the power transmission path between the crank shaft 14 and the front cover of the torque converter 16 is permitted. By setting the clutch K0 to the opened state, the transmission of power through the power transmission path between the crank shaft 14 and the front cover of the torque converter 16 is intercepted. By setting the clutch K0 to the slip engaged state, the transmission of power based on the torque capacity (transmission torque) of the clutch K0 through the power transmission path between the crank shaft 14 and the front cover of the torque converter 16.

The hybrid vehicle 10 includes a control system illustrated in FIG. 1. The electronic control unit 50 illustrated in FIG. 1 is constituted, for example, by a so-called microcomputer including a CPU, a RAM, a ROM, and an input and output interface. Various controls such as the drive control of the engine 12, the drive control of the electric motor MG, and the engaging force control of the clutch K0 are performed on the hybrid vehicle 10 by causing the CPU to process signals in accordance with a program stored in advance in the ROM using a temporary memory function of the RAM. The electronic control unit 50 is divided into a control section for the engine 12, a control section for the electric motor MG and an engaging force control section for the clutch K0 if necessary. The electronic control unit 50 may perform various controls by information communications with each other. In this embodiment, the electronic control unit 50 is an example of the controller of the hybrid vehicle 10.

As illustrated in FIG. 1, the electronic control unit 50 is supplied with various input signals detected by various sensors disposed in the hybrid vehicle 10. For example, a signal indicating an accelerator opening A_{CC} detected by an accelerator opening sensor 42 to correspond to a pressure applied to an accelerator pedal (not illustrated), a signal indicating a rotation speed (engine rotation speed) N_{E} of the engine 12 detected by an engine rotation speed sensor 44, and a signal indicating a vehicle speed V detected by a vehicle speed sensor 46 to correspond to the rotation speed of the output shaft 40 of the transmission 18 are input to the electronic control unit 50.

The units disposed in the hybrid vehicle 10 is supplied with various output signals from the electronic control unit 50. For example, a signal supplied to the starter 26 of the engine 12 for the start control of the engine 12, a signal supplied to the output controller 28 of the engine 12 for the drive control of the engine 12, a signal supplied to the inverter 56 for the drive control of the electric motor MG, a signal supplied to plural electromagnetic control valves in the hydraulic circuit 34 for the gear-shifting control of the transmission 18, a signal supplied to a linear solenoid valve in the hydraulic circuit 34 for the engagement control of the clutch K0 are supplied to the units from the electronic control unit 50.

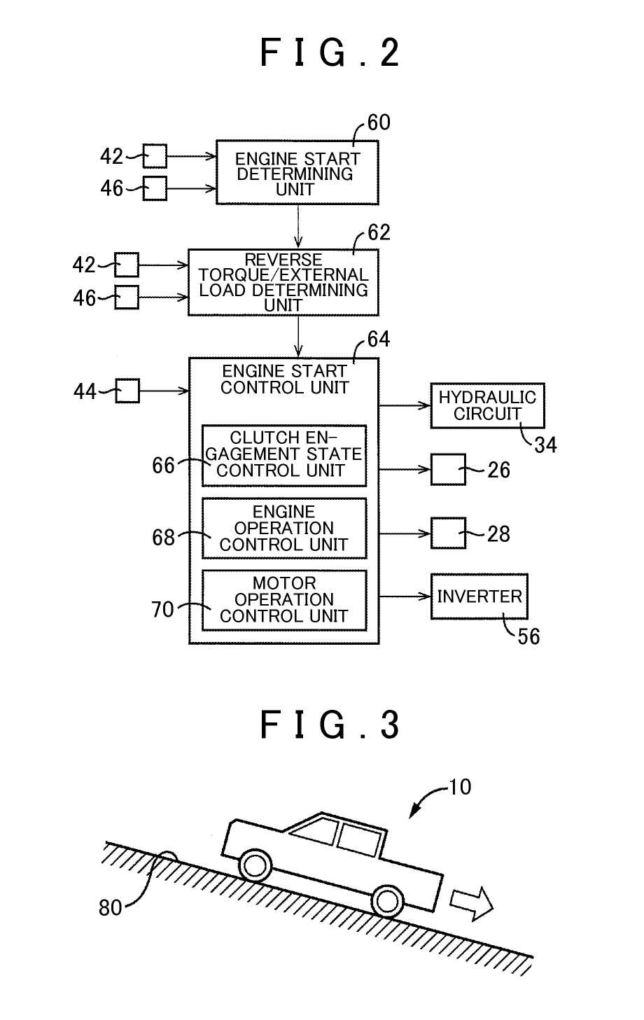

FIG. 2 is a functional block diagram illustrating a principal part of the control functions of the electronic control unit 50. An engine start determining unit 60 illustrated in FIG. 2 determines the start of the engine 12. For example, the engine start determining unit 60 determines the start of the engine 12 in a state where the clutch K0 is decoupled while the hybrid vehicle 10 is traveling, and outputs a start request of the engine 12. That is, the engine start determining unit 60 determines the start of the engine 12 when the EV traveling mode in which the electric motor MG is used as the traveling drive source is switched to the EHV mode (hybrid-traveling mode) in which the engine 12 and the electric motor MG are used as the drive source or the engine-traveling mode in which the engine 12 is used as the traveling drive source. Preferably, the engine start determining unit 60 determines the start of the engine 12 on the basis of the accelerator opening A_{CC} detected by the accelerator opening sensor 42 and the vehicle speed V detected by the vehicle speed sensor 46 from a predetermined relationship. For example, the engine start determining unit 60 determines the start of the engine 12 when the accelerator opening A_{CC} detected by the accelerator opening sensor 42 is equal to or greater than a prescribed threshold value, and outputs an engine start request. The engine start determining unit 60 determines the start of the engine 12 when the vehicle speed V detected by the vehicle speed sensor 46 is equal to or greater than a prescribed threshold value, and outputs an engine start request.

A reverse torque/external load determining unit 62 determines a reverse torque or an external load when the hybrid vehicle 10 is traveling. In this embodiment, the reverse torque means a torque in the reverse direction relevant the drive system of the hybrid vehicle 10. For example, the reverse torque is an example of a torque in the direction in which the vehicle moves reversely when the hybrid vehicle 10 is traveling forward. For example, the torque in the reverse direction in the output-side member of the clutch K0 (that is, the front cover of the torque converter 16) is an example of the reverse torque. In this embodiment, the external load is, for example, a factor for increasing energy for causing the vehicle to run forward when the hybrid vehicle 10 runs forward depending on the cumulative load or the presence or absence of towing of the hybrid vehicle 10.

Preferably, the reverse torque/external load determining unit 62 determines whether the reverse torque or the external load is equal to or greater than a threshold value when the hybrid vehicle 10 runs. Preferably, the reverse torque/external load determining unit 62 determines whether the hybrid vehicle 10 slides in the reverse direction. For example, as illustrated in FIG. 3, the reverse torque/external load determining unit 62 determines whether the hybrid vehicle 10 slides in the reverse direction (indicated by a white arrow in FIG. 3) on an uphill road 80 having a predetermined gradient or the like when the hybrid vehicle 10 runs forward. The reverse torque/external load determining unit 62 determines that the reverse torque or the external load is equal to or greater than the threshold value when it is determined that the hybrid vehicle 10 slides in the reverse direction. In other words, the reverse torque/external load determining unit 62 determines that the reverse torque or the external load is less than the threshold value when it is determined that the hybrid vehicle 10 does not slide in the reverse direction.

Preferably, the reverse torque/external load determining unit 62 detects the magnitude of the reverse torque or the external load when the hybrid vehicle 10 runs. For example, the reverse torque/external load determining unit 62 calculates the reverse torque or the external load on the basis of the accelerator opening A_{CC} detected by the accelerator opening sensor 42 and the vehicle speed V detected by the vehicle speed sensor 46 from a predetermined relationship. Alternatively, a torque sensor may be disposed in the output-side member of the clutch K0 (that is, the front cover of the torque converter 16) or the like and the reverse torque/external load determining unit 62 may detect the magnitude of the reverse torque or the external load on the basis of the detection result of the torque sensor.

An engine start control unit 64 starts the engine 12 when the start of the engine 12 is determined by the engine start determining unit 60, that is, when the engine start request is output. In order to perform such a control, the engine start control unit 64 includes a clutch engagement state control unit 66, an engine operation control unit 68, and a motor operation control unit 70.

The clutch engagement state control unit 66 is configured to control the engagement state of the clutch K0 by controlling the signal supplied to the linear solenoid valve of the hydraulic circuit 34. That is, the clutch engagement state control unit 66 is configured to control the engagement state of the clutch K0 among an engaged (completely-engaged) state, a slip engaged state, and an opened (completely-opened) state by controlling the hydraulic pressure supplied from the hydraulic circuit 34.

The engine operation control unit 68 is configured to control the operation of the engine 12 through the use of the starter 26 and the output controller 28. That is, the engine 12 is cranked through the use of the starter 26 at the time of starting the engine 12. The output of the engine 12 is controlled by the output controller 28 by controlling the injection of fuel from the fuel injector for the fuel injection control, controlling the ignition time of the igniter for the ignition time control, or the like in addition to controlling the operation of the electromagnetic throttle valve by the use of the throttle actuator for the throttle control.

The motor operation control unit 70 is configured to control the operation of the electric motor MG through the use of the inverter 56. For example, the motor operation control unit 70 is configured to control the output torque of the electric motor MG by controlling electric energy supplied from the electric storage device 58 to the electric motor MG via the inverter 56 or the like.

Preferably, the engine start control unit 64 couples the clutch K0 to start the engine 12 by the use of the driving force transmitted from the electric motor MG when the reverse torque or the external load detected (calculated) by the reverse torque/external load determining unit 62 is less than the threshold value in the start control of the engine 12. For example, the engine start control unit 64 couples the clutch K0 to start the engine 12 by the use of the driving force transmitted from the electric motor MG when the reverse torque/external load determining unit 62 determines that the hybrid vehicle 10 does not slide in the reverse direction. Preferably, the engine start control unit 64 performs a control of gradually increasing the torque capacity of the clutch K0 through the use of the clutch engagement state control unit 66. When the clutch K0 is switched to the slip engaged state or the like and thus the torque capacity occurs in the clutch K0 in the state where the hybrid vehicle 10 is traveling, the rotational force in the drive system on the downstream side (the electric motor MG) is input to the engine 12 via the clutch K0. The engine 12 is cranked and started with this rotational force. After the engine rotation speed N_{E} reaches a self-sustaining rotation speed, the driving of the engine 12 is started through the use of the output controller 28. That is, in the mode in which the engine 12 is started with the driving force transmitted from the electric motor MG, it is not necessary to crank the engine using the starter 26.

Preferably, when the clutch K0 is coupled to start the engine 12 with the driving force transmitted from the electric motor MG, the engine start control unit 64 generates an assist torque (compensating torque) by the electric motor MG through the use of the motor operation control unit 70 so as not to lower the vehicle speed V by the input of the rotational force from the electric motor MG to the engine 12. This assist torque may be a predetermined fixed value or may be a value calculated on the basis of the accelerator opening A_{CC} detected by the accelerator opening sensor 42 and the vehicle speed V detected by the vehicle speed sensor 46. That is, the engine start control unit 64 preferably couples the clutch K0 to start the engine 12 with the driving force output from the electric motor MG when the reverse torque or the external load detected by the reverse torque/external load determining unit 62 is less than the prescribed threshold value in the start control of the engine 12.

The engine start control unit 64 preferably starts the engine 12 using the starter 26 in the state where the clutch K0 is decoupled when the reverse torque or the external load detected (calculated) by the reverse torque/external load determining unit 62 is equal to or greater than the threshold value in the start control of the engine 12. That is, the engine 12 is cranked by the starter 26 in the state where the clutch K0 is decoupled, and the clutch K0 is coupled (made to engage) through the use of the clutch engagement state control unit 66 after the engine rotation speed N_{E} of the engine 12 detected by the engine rotation speed sensor 44 reaches a predetermined rotation speed (for example, self-sustaining rotation speed).

When the reverse torque or the external load is great in starting the engine 12 in the state where the clutch K0 is decoupled, the engine start control unit 64 is preferably configured to set the engine rotation speed N_{E} at the time of coupling the clutch K0 after starting the engine 12 to be higher than that when the reverse torque or the external load is small. Preferably, when the reverse torque/external load determining unit 62 determines that hybrid vehicle 10 slides in the reverse direction, the engine start control unit 64 sets the engine rotation speed N_{E} at the time of coupling the clutch K0 after starting the engine 12 in starting the engine 12 in the state where the clutch K0 is decoupled to be higher than that when it is determined that the hybrid vehicle 10 does not slide in the reverse direction. For example, the engine operation control unit 68 increases the engine rotation speed N_{E} at the time of coupling the clutch K0 after starting the engine 12 through the use of the output controller 28. That is, by sufficiently increasing the engine rotation speed N_{E} at the time of coupling the clutch K0 after starting the engine 12, it is possible to suppress the occurrence of an engine stall.

When the reverse torque or the external load is great in starting the engine 12 in the state where the clutch K0 is decoupled, the engine start control unit 64 preferably increases the engine rotation speed N_{E} at the time of coupling the clutch K0 after starting the engine 12 by a predetermined value, compared with the case where the reverse torque or the external load is small. Alternatively, the degree of increase in the engine rotation speed N_{E} may be changed depending on the reverse torque or the external load. Preferably, the degree of increase is a value capable of realizing the increase in the engine rotation speed N_{E} sufficient for suppressing the occurrence of an engine stall at the time of coupling the clutch K0 after starting the engine 12 and is a value, which is obtained in advance, for example, by experiment.

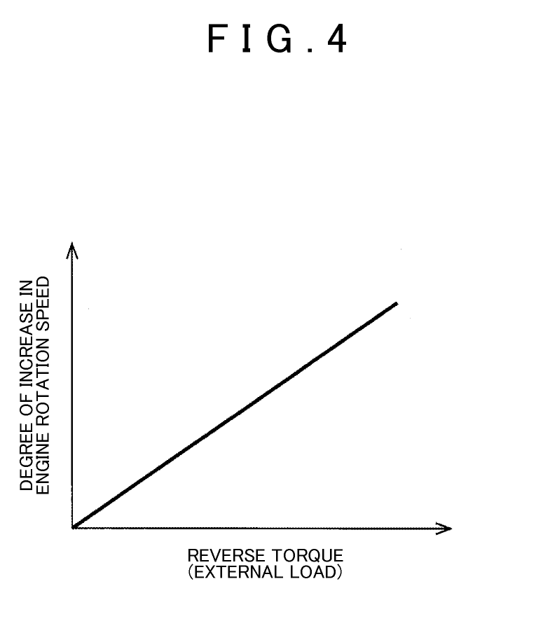

FIG. 4 is a diagram illustrating an example of a relationship between the reverse torque or the external load and the degree of increase in the engine rotation speed N_{E}, which is used for the increase control of the engine rotation speed N_{E} at the time of coupling the clutch K0 after starting the engine 12. As illustrated in FIG. 4, in starting the engine 12 in the state where the clutch K0 is decoupled, the engine start control unit 64 preferably sets the degree of increase in the engine rotation speed N_{E} to be greater as the reverse torque or the external load detected by the reverse torque/external load determining unit 62 becomes larger. FIG. 4 illustrates an example of a relationship in which the degree of increase in the engine rotation speed N_{E} increases in proportion to the reverse torque or the external load, but a relationship in which the degree of increase in the engine rotation speed N_{E} step-like increases with the increase in the reverse torque or the external load, a relationship in which the degree of increase in the engine rotation speed N_{E} exponentially increases, or the like may be used to determine the degree of increase in the engine rotation speed N_{E}.

In starting the engine 12 in the state where the clutch K0 is decoupled, the engine start control unit 64 preferably generates an assist torque (compensating torque) by the use of the electric motor MG through the motor operation control unit 70. Preferably, when the reverse torque/external load determining unit 62 determines that the hybrid vehicle 10 slides in the reverse direction, the engine start control unit 64 generates the assist torque for suppressing the sliding by the use of the electric motor MG through the motor operation control unit 70. In other words, at the time of coupling the clutch K0, the assist torque for suppressing a degree of decrease in the engine rotation speed N_{E} based on the rotational force input from the electric motor MG as small as possible is generated by the use of the electric motor MG through the motor operation control unit 70. The assist torque may be a predetermined fixed value or may be a value calculated on the basis of the accelerator opening A_{CC} detected by the accelerator opening sensor 42 and the vehicle speed V detected by the vehicle speed sensor 46.

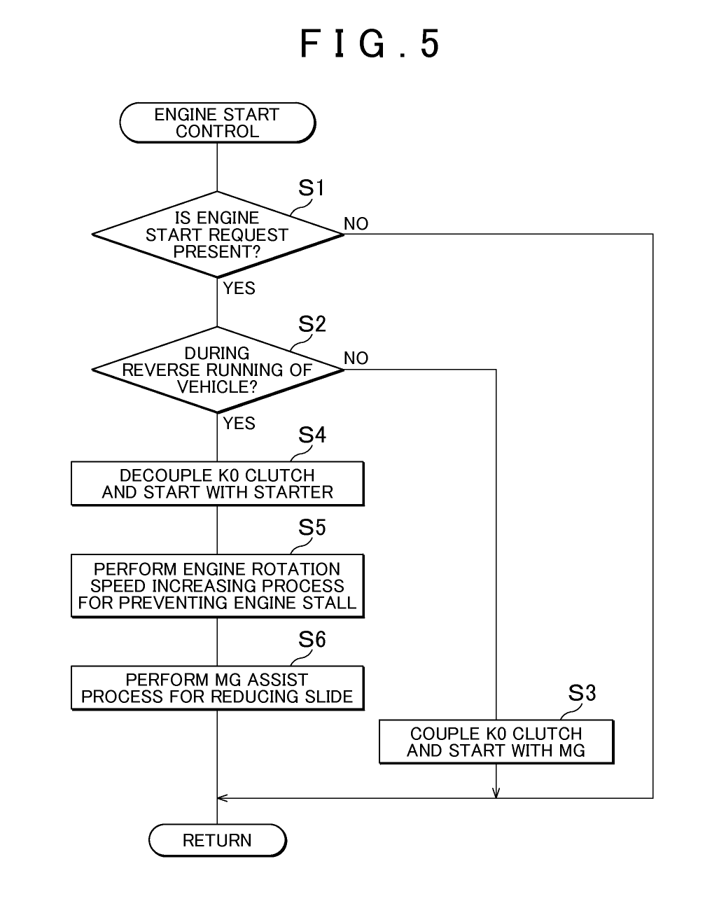

FIG. 5 is a flowchart illustrating principal parts of an example of the engine start control which is performed by the electronic control unit 50 and which is repeatedly performed with a predetermined cycle.

First, in step (hereinafter, step is not repeated) S1, it is determined that the engine 12 is started in the state where the clutch K0 is decoupled and it is determined whether the engine start request is output, on the basis of the accelerator opening A_{CC} detected by the accelerator opening sensor 42 and the vehicle speed V detected by the vehicle speed sensor 46. When the determination result of S1 is negative, this routine ends. When the determination result of S1 is positive, it is determined in S2 whether the reverse torque or the external load is equal to or greater than a threshold value, for example, whether the hybrid vehicle 10 slides in the reverse direction. When the determination result of S2 is negative, that is, when it is determined that the hybrid vehicle 10 does not slide in the reverse direction, the clutch K0 is coupled to start the engine 12 with the driving force transmitted from the electric motor MG in S3 and then the routine ends. When the determination result of S2 is positive, that is, when it is determined that the hybrid vehicle 10 slides in the reverse direction, the engine 12 is started by the starter 26 in the state where the clutch K0 is decoupled in S4. Then, in S5, the engine rotation speed N_{E} at the time of coupling the clutch K0 after starting the engine 12 increases to prevent an engine stall. Preferably, the degree of increase in the engine rotation speed N_{E} is determined depending on the reverse torque or the external load. Then, in S6, the assist torque for suppressing the sliding of the hybrid vehicle 10 in the reverse direction is generated by the electric motor MG and then the routine ends.

In the above-mentioned control, S1 corresponds to the operation of the engine start determining unit 60, S2 corresponds to the operation of the reverse torque/external load determining unit 62, S3 to S6 correspond to the operation of the engine start control unit 64, S3 corresponds to the operation of the clutch engagement state control unit 66, S4 and S5 corresponds to the operation of the engine operation control unit 68, and S3 and S6 correspond to the operation of the motor operation control unit 70.

In this embodiment, when the reverse torque or the external load is great in starting the engine 12 in the state where the clutch K0 is decoupled, the engine rotation speed N_{E} at the time of coupling the clutch K0 after starting the engine 12 is set to be higher than that when the reverse torque or the external load is small. Accordingly, even when the start of the engine 12 is determined in the state where the reverse torque or the external load relatively great such as a state where the hybrid vehicle 10 slides on an uphill road, the engine rotation speed can hardly be lower than the self-sustaining rotation speed of the engine 12 at the time of coupling the clutch K0 after starting the engine 12 and it is thus possible to appropriately suppress the occurrence of an engine stall. That is, it is possible to provide the electronic control unit 50 of the hybrid vehicle 10 capable of suppressing the occurrence of an engine stall.

In starting the engine 12 in the state where the clutch K0 is decoupled, the engine rotation speed N_{E} increases at the time of coupling the clutch K0 after starting the engine 12. As the reverse torque or the external load becomes larger, the degree of increase in the engine rotation speed N_{E} is set to be higher. Accordingly, it is possible to appropriately suppress the occurrence of an engine stall in a practical mode at the time of coupling the clutch K0 after starting the engine 12. The engine torque can be transmitted to the drive system earlier than in the control of increasing the engine rotation speed N_{E} by delaying the coupling timing of the clutch K0.

In starting the engine 12, when the reverse torque or the external load is less than the threshold value, the clutch K0 is coupled to start the engine 12 with the driving force transmitted from the electric motor MG. On the other hand, when the reverse torque or the external load is equal to or greater than the threshold value, the engine 12 is started by the starter 26 as the engine starter in the state where the clutch K0 is decoupled. Accordingly, it is possible to start the engine 12 with the driving force transmitted from the electric motor MG by coupling the clutch K0 when the reverse torque or the external load is relatively small, and it is possible to appropriately suppress the occurrence of an engine stall when the reverse torque or the external load is relatively large.

According to the invention, the clutch is preferably disposed in the power transmission path between the engine and the electric motor and cuts off or sets up the power transmission path depending on the engagement state thereof. In other words, the clutch is an engine/motor separating clutch that separates the engine from the drive system of the electric motor in the opened state thereof. The electric motor is connected to the output shaft of the engine so as to enable the transmission of power by the coupling of the clutch, but may not be directly connected thereto and may be indirectly connected thereto via another member.

The invention is suitably applied to a hybrid vehicle in which the crank shaft of the engine is connected to the rotor of the electric motor via the clutch and the torque converter and the transmission is disposed in the power transmission path between the rotor and the driving wheels. The invention may be applied to a hybrid vehicle including the transmission without disposing the torque converter in the power transmission path between the electric motor and the driving wheels.

The invention is suitably applied to the engine start control when the engine is started at the time of switching the EV traveling mode in which only the electric motor is used as the traveling drive source to the EHV mode (hybrid-traveling mode) in which the engine and the electric motor are used as the drive sources or the engine-traveling mode in which only the engine is used as the drive source.

While the exemplary embodiments of the invention have been described in detail with reference to the accompanying drawings, the invention is not limited to the embodiments but may be modified in various forms without departing from the gist thereof.

What is claimed is:

1. A controller for a hybrid vehicle, the hybrid vehicle including:
an engine,
a drive system,
a clutch configured to cut off or couple a power transmission path between the engine and the drive system,
an engine starter configured to start the engine, and
an electric motor configured to be connected to an output shaft of the engine by coupling the clutch,
the controller comprising:
an electronic control unit configured to set an engine rotation speed at the time of coupling the clutch after starting the engine, when a reverse torque or an external load is large in starting the engine in a state where the clutch is decoupled, to be higher than the engine rotation speed when the reverse torque or the external load is small.

2. The controller according to claim 1, wherein
the electronic control unit is configured to
(a) increase the engine rotation speed at the time of coupling the clutch after starting the engine when the engine starts in a state where the clutch is decoupled, and
(b) set a degree of increase in the engine rotation speed to be larger as the reverse torque or the external load becomes larger.

3. The controller according to claim 1, wherein
the electronic control unit is configured to
(i) couple the clutch and start the engine with a driving force transmitted from the electric motor, when the reverse torque or the external load is less than a threshold value in starting the engine, and
(ii) start the engine using the engine starter in a state where the clutch is decoupled when the reverse torque or the external load is equal to or greater than the threshold value in starting the engine.

4. The controller according to claim 1, wherein
the reverse torque is a torque in the direction the hybrid vehicle moves reversely when the hybrid vehicle is traveling forward, and
the external load is a factor that increases energy for causing the hybrid vehicle to travel forward when the hybrid vehicle travels forward.
